(19) United States
(12) Patent Application Publication
(10) Pub. No.: US 2019/0180099 A1
(43) Pub. Date: Jun. 13, 2019

(54) DOCUMENT-COMPOSITION ANALYSIS SYSTEM, DOCUMENT-COMPOSITION ANALYSIS METHOD, AND PROGRAM

(71) Applicant: KONICA MINOLTA, INC., Tokyo (JP)

(72) Inventor: Koichi TASHIRO, Tokyo (JP)

(73) Assignee: KONICA MINOLTA, INC., Tokyo (JP)

(21) Appl. No.: 16/212,602

(22) Filed: Dec. 6, 2018

(30) Foreign Application Priority Data
Dec. 12, 2017 (JP) 2017-237399

(51) Int. Cl. G06K 9/00; G06T 7/00; G06F 17/22

(52) U.S. Cl. CPC G06K 9/00469; G06T 2207/30176; G06F 17/2247; G06T 7/0002

(57) ABSTRACT

A document-composition analysis system includes a hardware processor that analyzes a logical composition of a document with mutually different methods, and determines a final logical composition of the document based on analyzed results of the hardware processor.

The entire disclosure of Japanese patent Application No. 2017-237399, filed on Dec. 12, 2017, is incorporated herein by reference in its entirety.

### BACKGROUND

### Technological Field

The present invention relates to a document-composition analysis system, a document-composition analysis method, and a program that are capable of determining the logical composition of a document.

### Description of the Related art

As a method of extracting beneficial information from text, there is a text mining method. According to the method, for example, negative-meaning words, such as “fault”, are extracted from text and are aggregated.

Generally, writing is often made including the composition of a chapter, a section, a subsection, and a body, for example. FIG. 18 illustrates an exemplary document including a chapter, sections, subsections, and bodies. In FIG. 18, there are provided “Developmental Status of New Products” as Chapter 1, “Product A” as Section 1, Chapter 1, “Software” as Subsection 1, Section 1, Chapter 1, and “In ∘∘ module (omitted) a review of the schedule is required” as the body thereunder. Similarly, there are provided “Hardware” as Subsection 2, Section 1, Chapter 1 and “ΔΔ module (omitted) there is no problem with Product B” in the body thereof. Similar composition is provided from Product B in Section 2, Chapter 1.

When text mining is performed to the entire text in such writing, the title texts of a chapter, a section, a subsection, and others become noise, and thus there is a possibility that beneficial information cannot be extracted. In FIG. 18, for example, “Developmental Status of New Products” in Chapter 1 becomes noise, and thus there is a possibility that beneficial information cannot be extracted.

Therefore, in a case where text mining is performed to an entire document, it is desirable that the text mining is performed after specifying a document composition including, for example, a chapter, a section, and a subsection, and removing title texts accompanied therewith. If the document composition can be specified, it can be recognized that which chapter, which section, or which subsection extracted information belongs to.

Examples of a method of analyzing a document composition are disclosed in JP 2010-282347 A, JP 2016-006661 A, JP 2017-10107 A, U.S. 2013311490, and U.S. Pat. No. 9,454,696. The methods of analyzing a document composition described in JP 2010-282347 A, JP 2016-006661 A, JP 2017-10107 A, U.S. 2013311490, and U.S. Pat No. 9,454,696 can be roughly classified into three types of tag analysis, text analysis, and image analysis.

In a case where a document composition is analyzed with the tag analysis, the text analysis, or the image analysis, rules for specifying a body part are provided. For example, as one of the rules to be provided in the text analysis, there is a rule of “counting the number of indention spaces and making a determination on the basis of the counted number”. When the document composition of FIG. 18 is analyzed with a text analysis method with the rule, text in the lowest layer is regarded as the bodies in the document and the others are regarded as the sections and the subsections. Accordingly, a body part can be specified. The method enables the hierarchical structure having, for example, the chapter and the sections, to be acquired.

However, there is a possibility that a document contains chapters, sections, subsections, and bodies that are all left-aligned (no indentation). FIG. 19 illustrates an exemplary document having a chapter, sections, subsections, and bodies that are all left-aligned. The document composition of the document of FIG. 19 cannot be analyzed with the rule of counting indentation spaces described above. In this case, if a rule of, for example, “determining text having a period (.) at the end as a body” is added, the document composition can be analyzed.

In this manner, in a case where a document composition cannot be analyzed with the first rule, typically, improvement of the rule or addition of a new rule enables a determination to be made.

However, because a method of describing a document varies among different individuals, countless descriptive methods are present. Thus, improvement of a rule or addition of a rule on those occasions requires time and effort. Improvement of a rule or addition of a rule may cause a problem, such as complication of the rule or a conflict between rules in an adding process.

### SUMMARY

The present invention is to solve the problem, and an object of the present invention is to provide a document-composition analysis system, a document-composition analysis method, and a program that are capable of analyzing a document composition without complicating a criterial rule for analysis.

To achieve the abovementioned object, according to an aspect of the present invention, a document-composition analysis system reflecting one aspect of the present invention comprises a hardware processor that analyzes a logical composition of a document with mutually different methods, and determines a final logical composition of the document based on analyzed results of the hardware processor.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram of an exemplary document-composition analysis system according to an embodiment of the present invention;

FIG. 2 is a block diagram of the schematic configuration of a server as a document-composition analysis device, according to an embodiment of the present invention;

FIG. 3 is a flowchart of an outline of processing in a case where the server analyzes a document composition;

FIG. 4 is a diagram of a state where the server makes requests to a plurality of other servers for analysis and derives a final determined result from analyzed results thereof;

FIG. 5 is a flowchart of the flow of processing in a case where tag analysis is performed;

FIG. 6 is a flowchart of the flow of processing in a case where text analysis is performed;

FIG. 7 is a flowchart of the flow of processing in a case where image analysis is performed;

FIG. 8 is a flowchart of the flow of final determination processing to be performed on the basis of a plurality of analyzed results;

FIG. 9 is a table of a list of analysis methods and the descriptions of rules;

FIG. 10 is a view of exemplary tags acquired from a document;

FIG. 11 is a table of an exemplary determined result with the tag analysis;

FIG. 13 is a table of an exemplary determined result with the text analysis (a rule of TEXT-2);

FIG. 14 is a view of a state where a document composition is analyzed with the distance from the left end of an image to the left end of each character string;

FIG. 15 is a table of an exemplary determined result with the image analysis;

FIG. 16 is a table of a list of respective methods of calculating the degree of confidence for the rules;

FIG. 17 illustrates a table of an analyzed result having duplicate contents between the tag analysis and the text analysis and a table of an analyzed result with the image analysis;

FIG. 18 is a view of an exemplary document to be analyzed; and

FIG. 19 is a view of an exemplary document to be analyzed, different from that of FIG. 18.

### DETAILED DESCRIPTION OF EMBODIMENTS

Hereinafter, one or more embodiments of the present invention will be described with reference to the drawings. However, the scope of the invention is not limited to the disclosed embodiments.

### First Embodiment

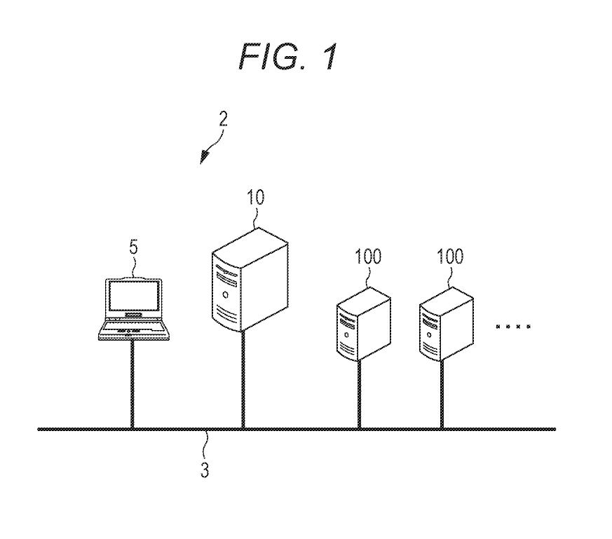

FIG. 1 is a diagram of an exemplary document-composition analysis system 2 including a PC 5, according to an embodiment of the present invention. The document-composition analysis system 2 includes a server 10, the PC 5, and a plurality of servers 100 connected through a network 3, such as a local area network (LAN).

The PC 5 is a terminal device to be used by a user, such as a personal computer. The PC 5 including, for example, a central processing unit (CPU), a read only memory (ROM), and a random access memory (RAM), operates on the basis of various programs, such as an operating system (OS) and an application program. In the embodiment of the present invention, the PC 5 creates and saves a document, and/or makes a request to the server 10 for analysis of a document structure.

When receiving a request for analysis of a document structure from the PC 5, the server 10 analyzes the document structure with a plurality of mutually different methods. Then, the server 10 acts to determine the final logical structure of the document on the basis of a plurality of results acquired by the analyses and to return a result of the determination to the PC 5. Note that, in the embodiment of the present invention, the server 10 itself may analyze a document structure with the plurality of different methods or the plurality of servers 100 may undertake the analysis.

Each of the servers 100 undertakes the analysis of the document structure in response to a request from the server 10. Although the two servers 100 are illustrated in FIG. 1, the number of servers 100 may be three or more. The plurality of servers 100 analyzes the document structure with mutually different methods.

In the embodiment of the present invention, the servers 10 analyze the structure of a document with the plurality of mutually different methods (or request the plurality of servers 100 to undertake the analysis), and determine the final logical composition of the document on the basis of results of the plurality of analyses. The final logical composition of the document is determined from the results acquired by the analyses with the plurality of methods. Therefore, even in a case where the document composition cannot be analyzed by a certain method, the final logical composition of the document can be reliably determined without improvement of a rule or addition of a rule in the method.

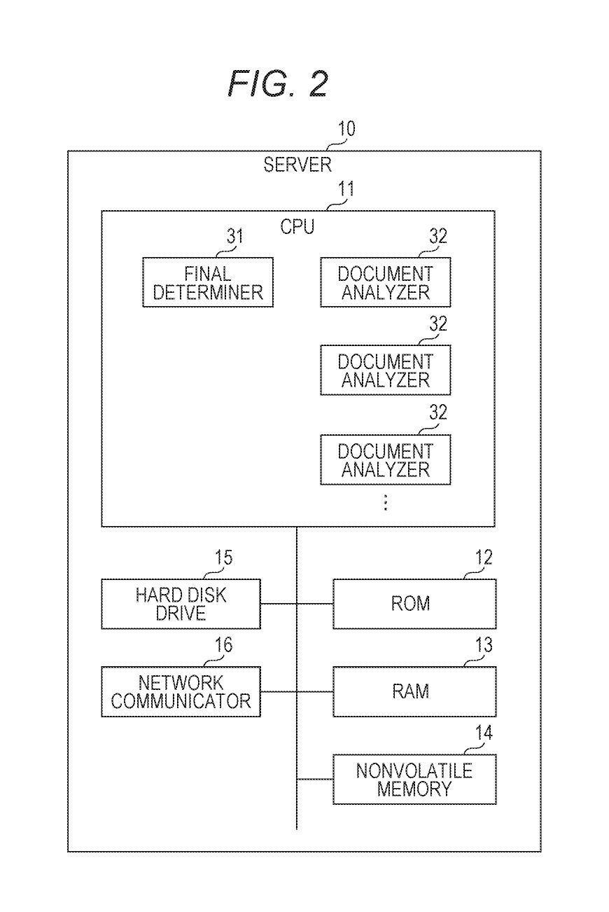

FIG. 2 is a block diagram of the schematic configuration of the server 10. The server 10 has a central processing unit (CPU) 11 that controls the operation of the server 10 in a unified manner. For example, a read only memory (ROM) 12, a random access memory (RAM) 13, a nonvolatile memory 14, a hard disk drive 15, and a network communicator 16 are connected to the CPU 11 through a bus.

On the basis of an OS program, the CPU 11 executes, for example, middleware or an application program thereon. Each of the ROM 12 and the hard disk drive 15 stores various programs, and the CPU 11 performs various types of processing in accordance with the programs, to achieve each function of the server 10.

The RAM 13 is used, for example, as a work memory that temporarily stores various types of data when the CPU 11 performs processing on the basis of a program or as an image memory that stores image data.

The nonvolatile memory 14 includes a memory (flash memory) in which the content stored therein is not destroyed even when power is turned off, and is used, for example, for saving various types of setting information. The hard disk drive 15, including a large-capacity nonvolatile storage, stores various programs and various types of data in addition to printing data, image data and the like.

The network communicator 16 functions to communicate with another external device, such as the PC 5 or each server 100, through the network 3.

In the embodiment of the present invention, the CPU 11 acts as a plurality of document analyzers 32 that analyzes the logical composition of a document with mutually different methods, and as a final determiner 31 that determines the final logical composition of the document on the basis of analyzed results of the plurality of document analyzers 32.

The server 10 may analyze a document with the plurality of document analyzers 32 in the host device, or may request the plurality of external servers 100 to analyze the document.

Each of the plurality of servers 100 is capable of communicating with the server 10 and analyzes the document in response to the request from the server 10 and returns a result thereof to the server 10. In the embodiment of the present invention, in a case where the plurality of servers 100 is requested to analyze the document, the servers 100 act as the document analyzers 32.

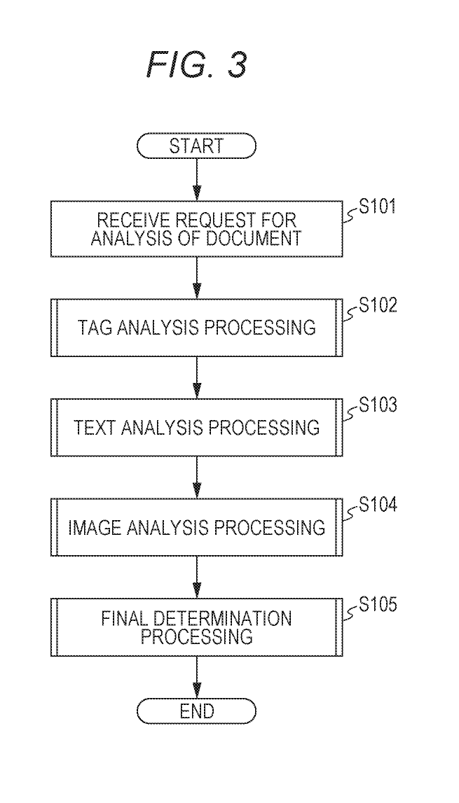

Next, an outline of processing to be performed by the server 10 will be described with reference to FIG. 3. First, a document and a request for analysis of the structure of the document are received from the PC 5 (step S101). Next, the document is analyzed with the plurality of mutually different methods. In the embodiment of the present invention, analysis processing with tag analysis (step S102), analysis processing with text analysis (step S103), and analysis processing with image analysis (step S104) are performed.

On the basis of analyzed results acquired at steps S102 to S104, determination processing of a final document structure is performed (step S105), and then the present processing finishes. Each of the analyzed results acquired at steps S102 to S104 has the degree of confidence to be described later (corresponding to the degree of reliability in the embodiment of the present invention) already set therefor. At step S105, the determination processing of a final document structure is performed in accordance with, for example, the degree of reliability.

In the analysis processing with the tag analysis and the analysis processing with the text analysis, a rule for analyzing a structure is provided and the document structure is analyzed in accordance with the rule. The number of rules to be set may be one or more than one. In a case where a plurality of rules is set, the analysis processing is performed to the document for every rule.

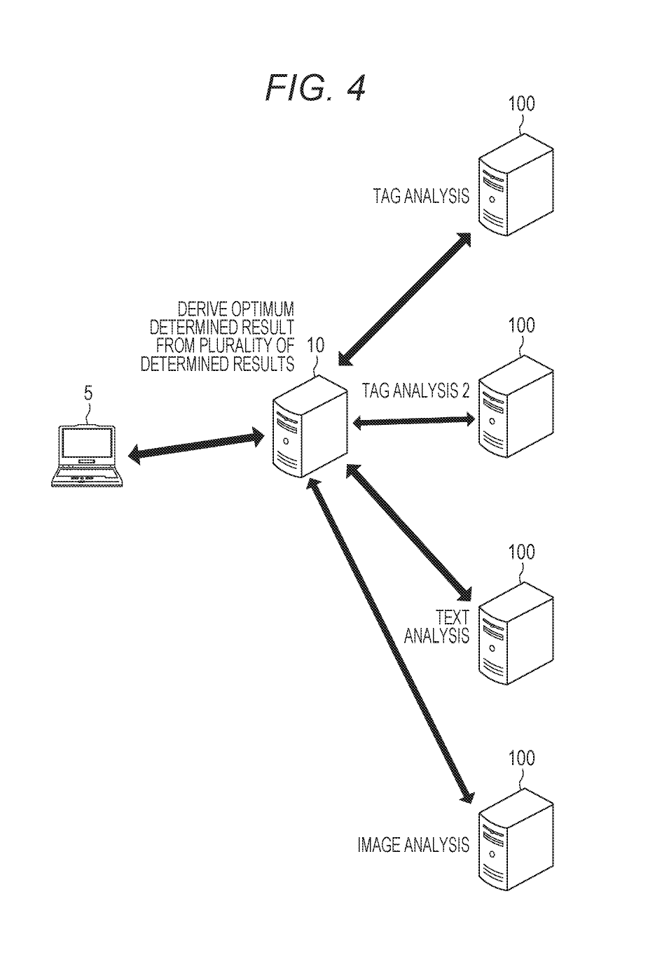

Note that the server 10 may perform the analysis processing at steps S102 to S104 with the host device, or may request the external servers 100 to perform the analysis processing. FIG. 4 illustrates a state where the plurality of external servers 100 is requested to perform the analysis processing at steps S102 to S104.

In FIG. 4, each server 100 that has received the request performs the analysis processing to the document with the mutually different method. In FIG. 4, although two servers 100 perform analysis with the tag analysis, the two servers 100 perform the analysis with mutually different rules.

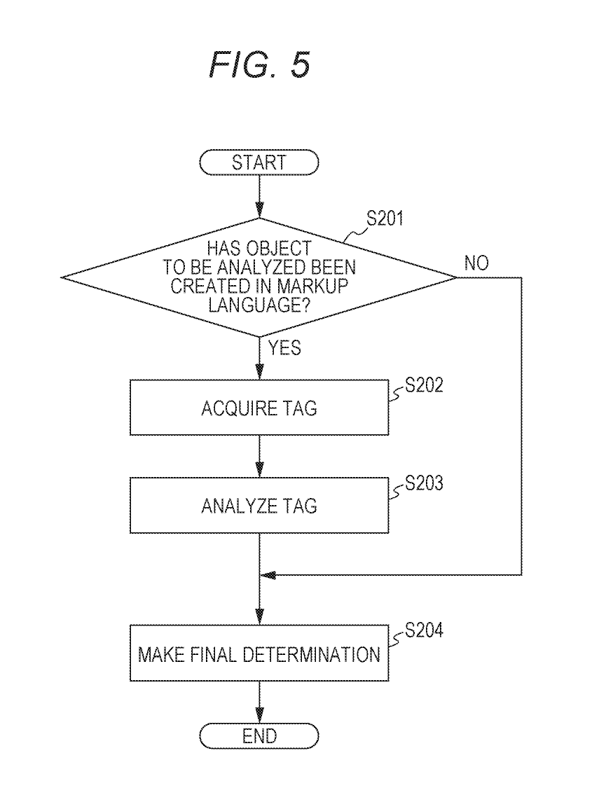

Next, each piece of analysis processing will be described. FIG. 5 illustrates the flow of the analysis processing with the tag analysis to be performed at step S102 of FIG. 3. First, if the document to be analyzed is not created in a markup language, such as XML (step S201; No), the processing proceeds to step S204.

In a case where the document to be analyzed is created in the markup language (step S201; Yes), a tag is acquired (step S202) and then the acquired tag is analyzed (step S203).

The analysis at step S203 is performed in accordance with a previously determined rule. For example, it is assumed that a tag indicating a chapter or a body is used in the document described in the markup language (the tag is described in a form, such as “<element name>content</element name>, and is described in accordance with an element name and an attribute that have been arbitrarily defined or previously defined). In the analysis, examples of the rule include a rule of searching for a ∘∘ tag and a rule of searching for a xx tag. For example, which one of a chapter, a section, a subsection, and a body each passage in the document corresponds to is analyzed in accordance with the rules.

After that, on the basis of an analyzed result at step S203, a final determined result of a document logical composition is derived as the tag analysis as to which one of the chapter, the section, the subsection, and the body each passage in the document corresponds to (step S204), and then the present processing finishes. In the case where the document is not described in the markup language, a determination is made as analysis failure.

Note that, in a case where a plurality of rules is provided and the tag analysis is performed for each of the rules, all final determined results thereof may be used in the final determination processing at step S105 of FIG. 3. Alternatively, from the final determined results thereof, a comprehensive final determined result may be determined on the basis of, for example, the degree of confidence for every rule, and the comprehensive final determined result may be used as the final determined result of the tag analysis at step S105 of FIG. 3.

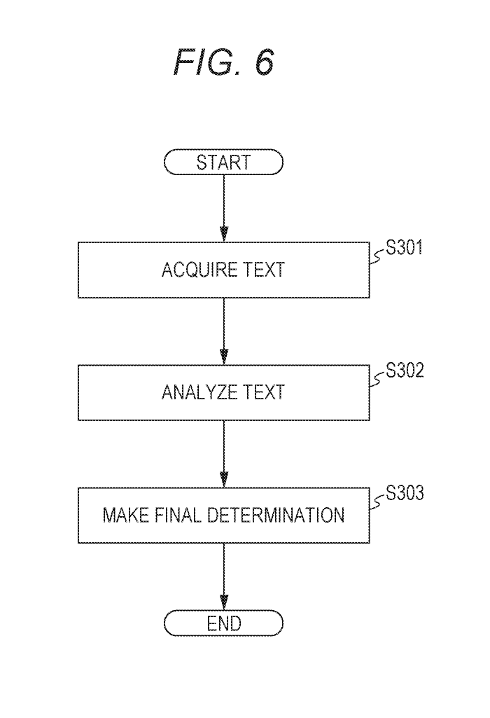

FIG. 6 illustrates the flow of the analysis processing with the text analysis to be performed at step S103 of FIG. 3. First, text is acquired from the document to be analyzed (step S301). Next, the acquired text is analyzed (step S302).

After that, on the basis of an analyzed result at step S302, a final determined result of a document logical composition is derived as the text analysis, as to which one of the chapter, the section, the subsection, and the body each passage in the document corresponds to (step S303), and then the present processing finishes.

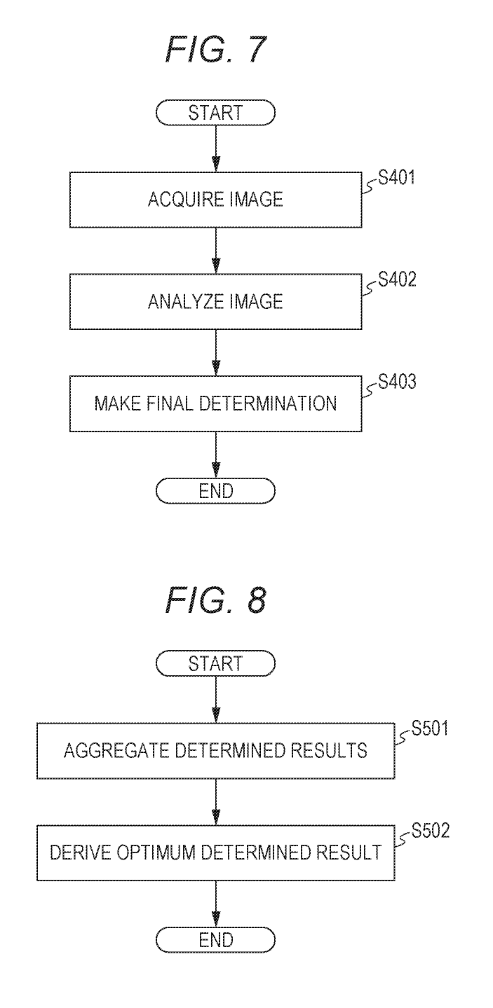

FIG. 7 illustrates the flow of the analysis processing with the image analysis to be performed at step S104 of FIG. 3. First, an image of the document to be analyzed is acquired (step S401). Next, the acquired image is analyzed (step S402).

After that, on the basis of an analyzed result at step S402, a final determined result of a document logical composition is derived as the image analysis, as to which one of the chapter, the section, the subsection, and the body each passage in the document corresponds to (step S403), and then the present processing finishes.

FIG. 8 illustrates the flow of the final determination processing to be performed at step S105 of FIG. 3. First, the results of the final determination in the processing of FIGS. 5 to 7 are aggregated (step S501). Next, an optimum determined result is derived on the basis of the aggregated determined result (step S502), and then the present processing finishes. A method of deriving the optimum determined result will be described later.

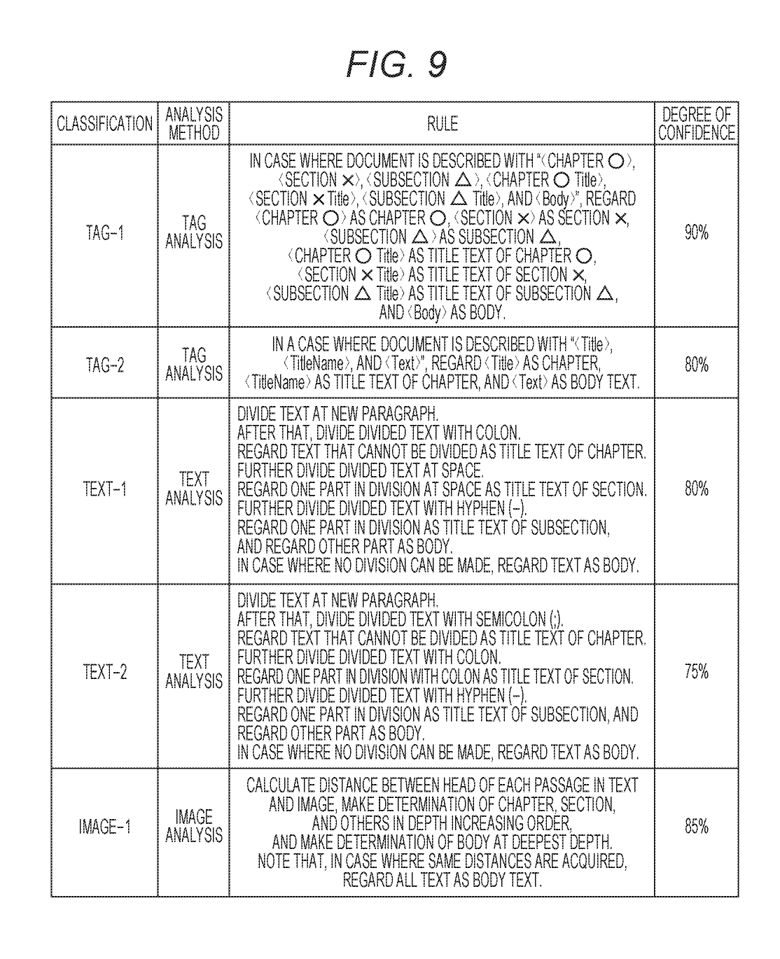

Next, respective specific exemplary rules of the analysis methods to be used by the document-composition analysis system 2 in a case of analyzing a document will be described with reference to FIGS. 9 to 17.

### Specific Example 1

FIG. 9 illustrates a list of respective rules set in the analysis methods to be carried by the document-composition analysis system 2 (rule table). In the rule table of FIG. 9, two types of rules for the tag analysis (TAG-1 and TAG-2), two types of rules for the text analysis (TEXT-1 and TEXT-2), and one type of rule for the image analysis (IMAGE-1) are registered. The degree of confidence is previously set for each rule. In a case where respective analyzed results with the rules are disagreed, the result of a rule that has a higher degree of confidence than the others is prioritized.

The detailed description of each rule and an analyzed result in the analysis with each rule will be described. First, the two rules (TAG-1 and TAG-2) to be used in the tag analysis will be described.

The rule of TAG-1 is to “search for a tag in which <Chapter ∘>, <Section x>, <Subsection Δ>, <Chapter ∘ Title>, <Section x Title>, <Subsection Δ Title>, or <Body> is described, and recognize the tag as a chapter, a section, or a subsection”.

The rule of TAG-2 is to “search for a tag in which <Title>, <TitleName>, or <Text>is described, and recognize the tag as a chapter, a title text, or a body text”.

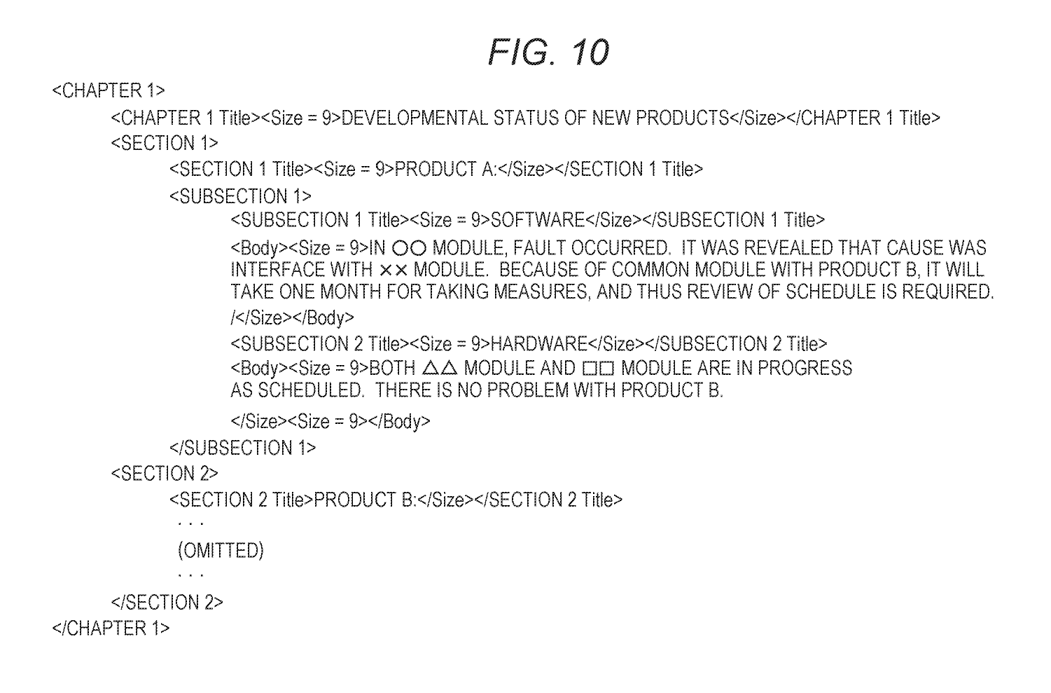

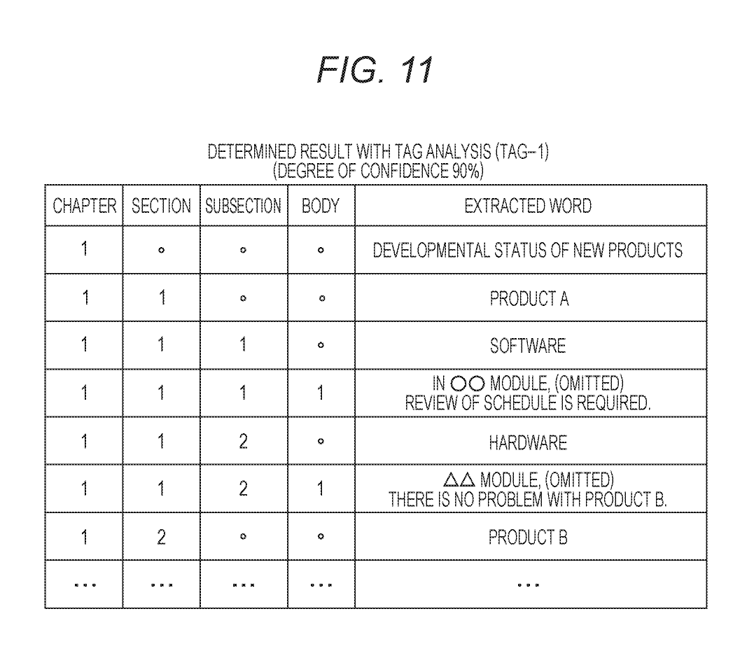

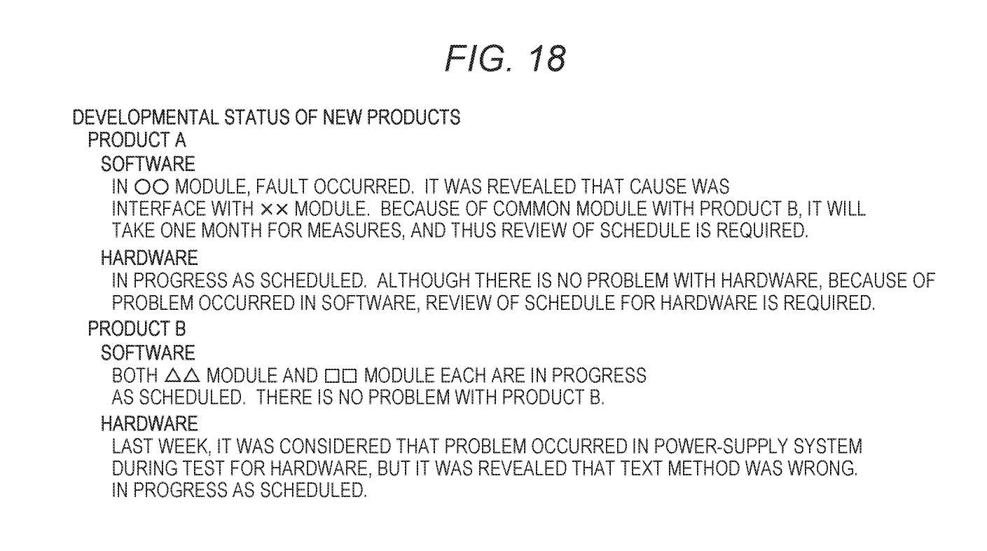

Next, an exemplary case where the tag analysis is performed with each rule described above will be described. In a case where the tag analysis is performed, a tag of the document to be analyzed is acquired. FIG. 10 illustrates XML tags of a document of FIG. 18 as exemplary tags. FIG. 11 illustrates a determined result acquired in a case of performing the tag analysis on the XML tags of FIG. 10 with the rule of TAG-1.

The determined result of FIG. 11 shows which chapter, which section, which subsection, or which body each extracted word, such as “Developmental Status of New Products”, “Product A”, “Software”, “In ∘∘ module (omitted) a review of the schedule is required”, or “Hardware”, belongs to. For example, the word of “Product A” belongs to Section 1, Chapter 1, and thus can be determined as a word acting as a section. The word of “Software” belongs to Subsection 1, Section 1, Chapter 1, and thus can be determined as a word acting as a subsection. The word of “In ∘∘ module (omitted) a review of the schedule is required” belongs to Body 1, Subsection 1, Section 1, Chapter 1, and thus can be determined as the body part of Subsection 1, Section 1, Chapter 1. Note that the degree of confidence for the determined result in a case of performing the tag analysis with the rule of TAG-1 illustrated in FIG. 11 is 90%.

In a case of performing the tag analysis on the XML tags of FIG. 10 with the rule of TAG-2, because there is no part described in English and, thus, the rule is inapplicable, a result indicating that determination is impossible to be made is acquired. The degree of confidence for the determined result in the performance of the tag analysis with the rule of TAG-2 is 80%.

In a case of performing the tag analysis with the two rules, because a normal determined result is acquired only in the analysis with the rule of TAG-1, the determined result in the analysis with the rule of TAG-1 is adopted in the tag analysis.

Next, the two rules (TEXT-1 and TEXT-2) to be used in the text analysis will be described.

The rule of TEXT-1 is as follows:
Divide text at a new paragraph.
After that, divide the divided text with a colon.
Regard text that cannot be divided as the title text of a chapter.
Further divide the divided text at a space.
Regard one part in the division at the space as the title text of a section.
Further divide the divided text with a hyphen (-).
Regard one part in the division as the title text of a subsection, and regard the other part as a body.
In a case where no division can be made, regard the text as a body.

The rule of TEXT-2 is as follows:
Divide text at a new paragraph.
After that, divide the divided text with a semicolon (;).
Regard text that cannot be divided as the title text of a chapter.
Further divide the divided text with a colon.
Regard one part in the division with the colon as the title text of a section.
Further divide the divided text with a hyphen (-).
Regard one part in the division as the title text of a subsection, and regard the other part as a body.
In a case where no division can be made, regard the text as a body.

FIG. 12 illustrates an analyzed result acquired in a case of performing the text analysis on the document of FIG. 18 with the rule of TEXT-1. The analyzed result of FIG. 12 shows which chapter, which section, which subsection, or which body each extracted word, such as “Developmental Status of New Products”, “Product A”, “Software In ∘∘ module (omitted) There is no problem with Product B”, or “Product B”, belongs to. For example, the word of “Software In ∘∘ module (omitted) There is no problem with Product B” belongs to Body 1, Section 1, Chapter 1, and thus can be determined as the body part of Section 1, Chapter 1. Note that the degree of confidence for the determined result in the performance of the text analysis with the rule of TEXT-1 illustrated in FIG. 12, is 80%.

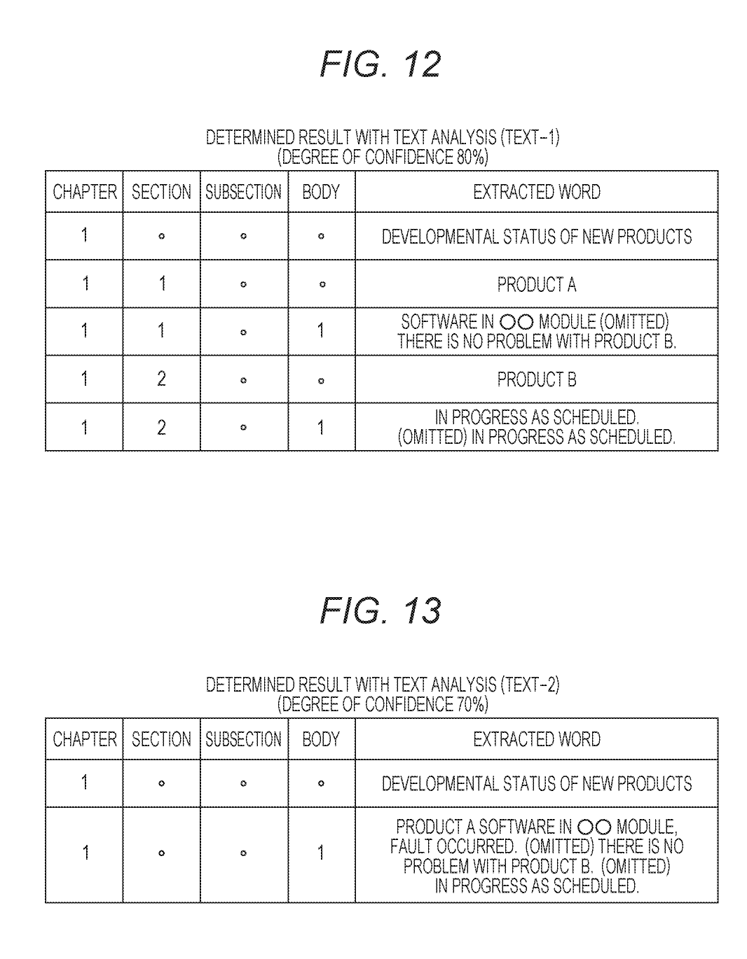

FIG. 13 illustrates an analyzed result acquired in a case of performing the text analysis on the document of FIG. 18 with the rule of TEXT-2. The analyzed result of FIG. 13 shows which chapter, which section, which subsection, or which body the respective extracted words of “Developmental Status of New Products” and “Product A Software In ∘∘ module (omitted) There is no problem with Product B (omitted) In progress as scheduled” belong to. For example, the word of “Product A Software In ∘∘ module (omitted) There is no problem with Product B (omitted) In progress as scheduled” belongs to Body 1, Chapter 1, and thus can be determined as the body part of Chapter 1. Note that the degree of confidence for the determined result in the performance of the text analysis with the rule of TEXT-2 illustrated in FIG. 13, is 70%.

Differently from the tag analysis, both of the rules of TEXT-1 and TEXT-2 are applicable to the text analysis. In this manner, in a case where a plurality of rules is applicable normally, the respective determined results of the rules are compared in the degree of confidence, and a determined result having a highest degree of confidence is determined as a representative. Here, because the determined result of TEXT-1 is higher in the degree of confidence than the determined result of TEXT-2, the determined result of TEXT-1 is adopted as the determined result of the text analysis.

Next, a rule (IMAGE-1) to be used in the image analysis, will be described.

The rule of IMAGE-1 is as follows:
Calculate the distance between the head of each passage in text and an image.
Make a determination of a chapter, a section, and others in depth increasing order.
Make a determination of a body at the deepest depth.
In a case where the same distances are acquired, regard all the text as a body text.

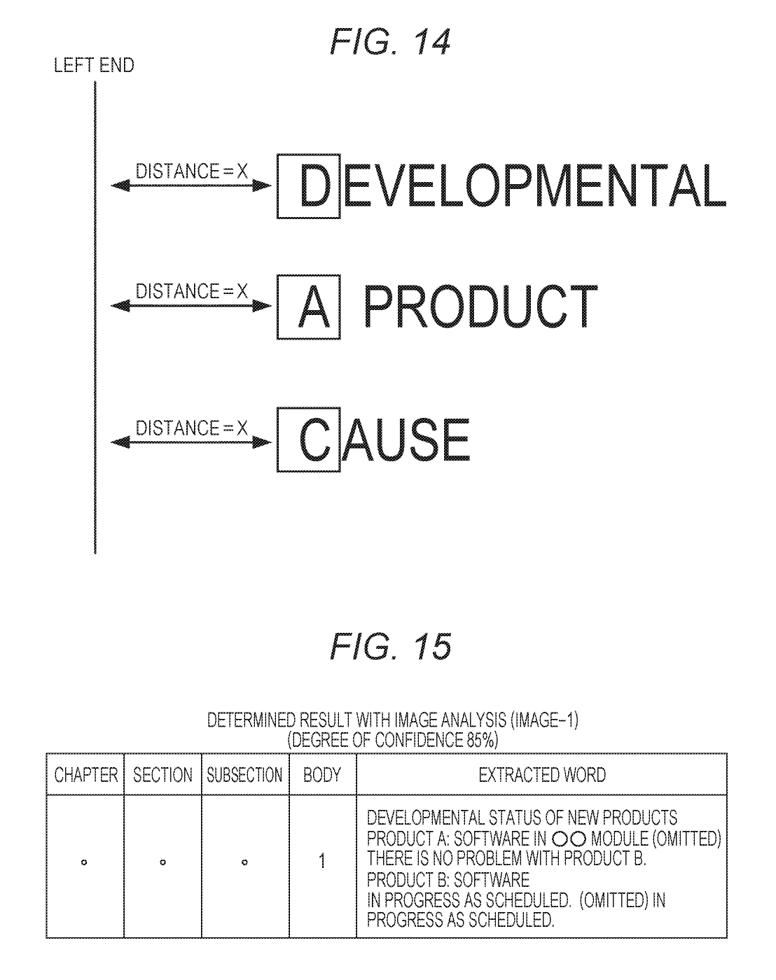

FIG. 14 illustrates exemplary analysis with the mile of IMAGE-1. In the image analysis, performance of character recognition acquires the regions of head characters in text (squares in black in the figure), and then the distance between the left of each square in black and the left end of the image is calculated, Specifically, the distance from the left end of the image to the left-end character of each word (“D”, “P”, or “C” in the figure) is calculated. On the basis of a result thereof, it is determined which part of a chapter, a section, a subsection, and a body each word corresponds to.

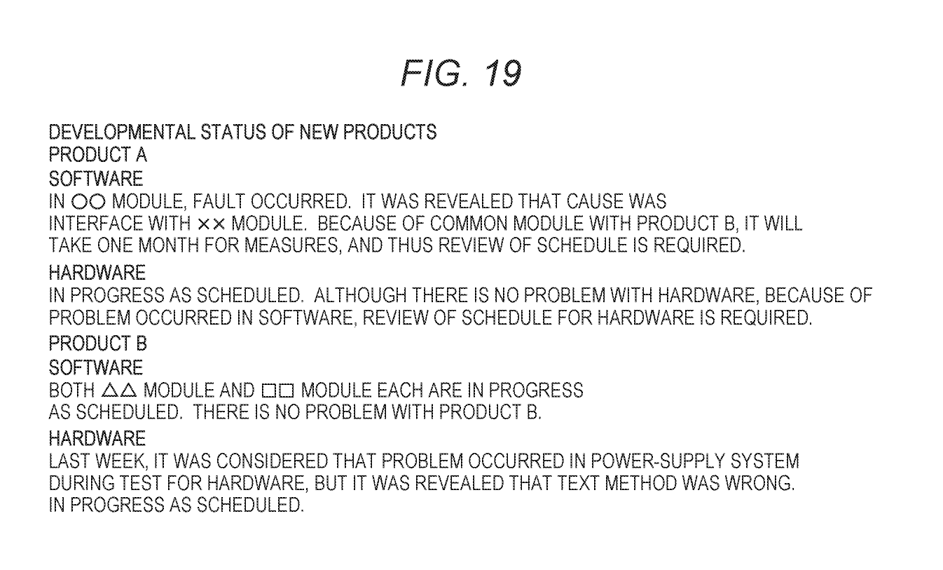

FIG. 15 illustrates a result in a case of performing the image analysis on a document of FIG. 19 with the rule of IMAGE-1. Because all passages are left-aligned in the document of FIG. 19, it is determined that all words in the entire document are included in only one body text. Because the image analysis has only one rule, the determined result is adopted. The degree of confidence for the determined result is 85%.

After settlement of the determined results with the three analysis methods, as described in FIG. 8, the results are aggregated and then a final determined result is derived. The aggregation of the respective degrees of confidence for the results of the tag analysis, the text analysis, and the image analysis, indicates 90, 80, and 85%. Thus, the result of the tag analysis having a highest degree of confidence is adopted, and the result of the document structure analysis is settled. After the settlement, the extracted result of the chapter, the section, the subsection, or the body is output.

Note that, although the logical composition is determined with segments made with specific marks in the text analysis in the present example, the rule of marks for segments is insufficient. Thus, the logical composition cannot be determined successfully. Although the logical composition is determined with a space in front of the head of a passage in the image analysis, no space is provided in front of the head of a passage in the present example. Thus, it is necessary to set a different rule similarly to the text analysis. In a case where a rule of determining a document logical composition is established with a single method, it is necessary that the analysis rule thereof is increased in number or detailed settings are made, resulting in complication of the rule of the signal method. As in the present embodiment, the use of the plurality of methods enables the logical composition to be specified from various points of view; the analysis rule to be prevented from increasing in number or complicating, and a document logical composition to be specified with a combination of simple rules.

### Second Embodiment

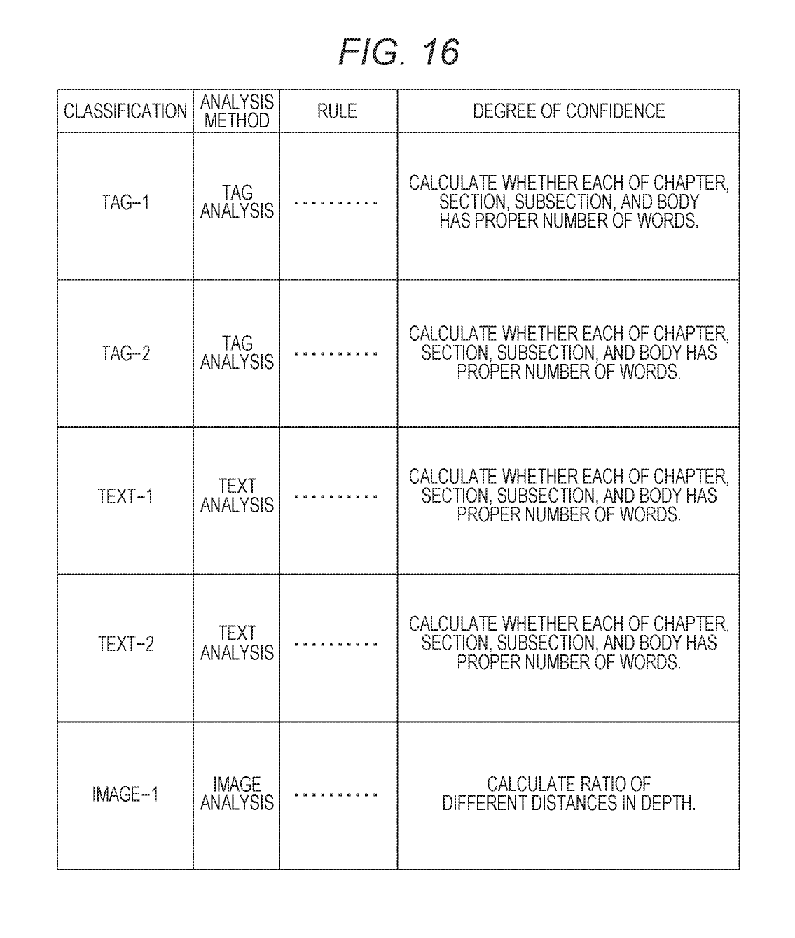

In the first embodiment, the degree of confidence is previously set for a case of performing the analysis with each rule. In a second embodiment, a case where the degree of confidence varies depending on objects to be analyzed will be described. A method of calculating the degree of confidence is previously set for each rule. FIG. 16 illustrates a list of respective methods of calculating the degree of confidence for the respective rules described in FIG. 9.

In FIG. 16, each of the methods of calculating the degree of confidence in the four rules of TAG-1, TAG-2, TEXT-1, and TEXT-2 adopts “a method of calculating whether a chapter, a section, a subsection, and a body each have a proper number of words”, and the rule of IMAGE-1 adopts “a method of calculating the ratio of different distances in depth”.

A specific example in a case where analysis is performed with the rule of TAG-1, will be described. It is assumed that the result described in FIG. 11 is extracted by the analysis with the rule of TAG-1. The number of words is calculated from the extracted result. For example, because the title text of a chapter is “Developmental Status of New Products”, the number of words is “5”. Because the title text of a section is “Product A:”, the number of words is “3”. Then, for example, calculation as to whether any of the chapter and the section have an extremely deviated number of words as a title text or as to whether the number of words in a body exceeds the number of words in the chapter is made, and then the degree of confidence is calculated. The criterial number of words may be previously set or may be allowed to be set by a user.

In this manner, in a case where the degree of confidence is determined dynamically, final determination settles a document logical composition having a highest degree of confidence from the respective results analyzed with the rules.

### Third Embodiment

In the first and second embodiments, the rule having a highest degree of confidence is adopted. In a third embodiment, in a case where duplicate results are present between analyzed results, the duplicate results are given priority when a document logical composition is settled.

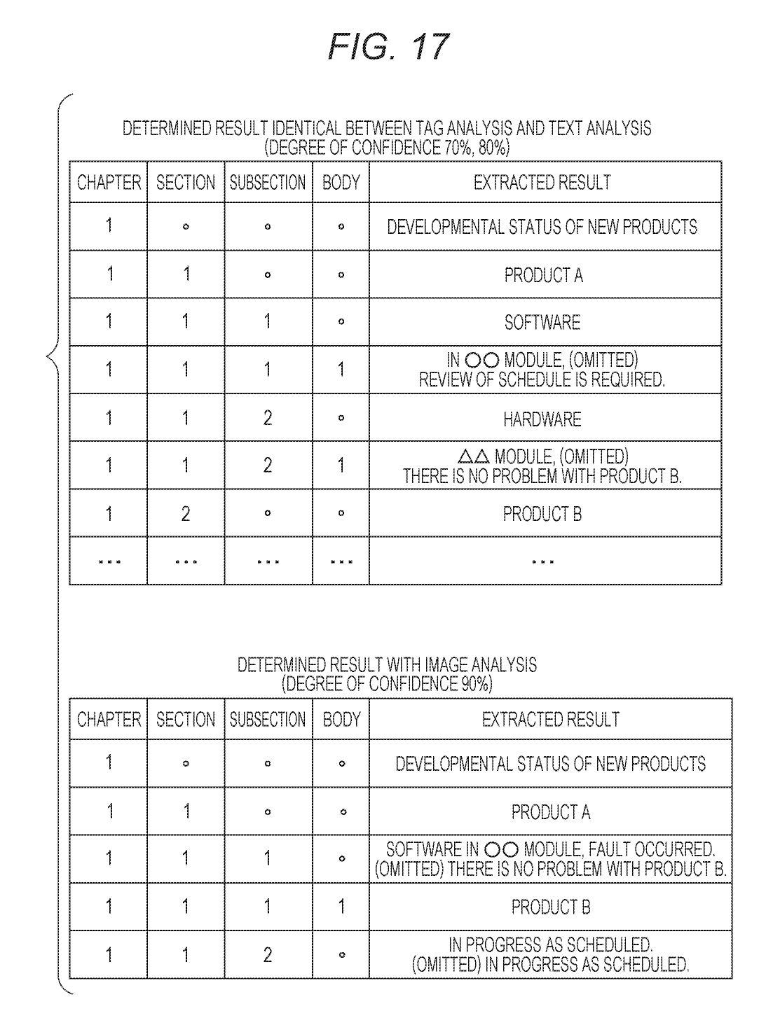

FIG. 17 illustrates, for a document analyzed with the live rules described in FIG. 9, representative analyzed results of the tag analysis, the text analysis, and the image analysis determined on the basis of the respective degrees of confidence in the rules. In FIG. 17, the respective analyzed results of the tag analysis and the text analysis are agreed. The degree of confidence in the tag analysis is 70%, and the degree of confidence in the text analysis is 80%. The analyzed result of the image analysis is different from the respective analyzed results of the tag analysis and the text analysis, and the degree of confidence is 90%.

In this case, the respective degrees of confidence in the tag analysis and the text analysis are inferior to the degree of confidence in the image analysis. However, because the respective logical composition results of the tag analysis and the text analysis are identical, the respective results of the tag analysis and the text analysis are given priority based on majority rule when final determination settles a document logical composition.

Note that, even when duplicate results are present, in a case where the sum of the respective degrees of confidence therefor is below a certain value, a result having a highest degree of confidence may be given priority when a document logical composition is settled.

### Fourth Embodiment

In the third embodiment, the representative analyzed results of the tag analysis, the text analysis, and the image analysis are determined from the respective analyzed results with the rules; and, if duplicate analyzed results are present in the representatives, the results are given priority when a document logical composition is settled. In a fourth embodiment, searching is performed for duplicate results from all analyzed results with the rules. If duplicate results are present, the duplicate results are given priority when a document logical composition is settled.

### Fifth Embodiment

In the first to fourth embodiments, the analysis is performed with all the rules illustrated in FIG. 9. In a fifth embodiment, with each rule having been weighted, instead of performing analysis with all the rules, analysis is performed only with a rule meeting a specific condition, such as a rule having a highest degree of confidence or a rule having a certain degree of confidence or more. This arrangement enables the frequency of analysis to be reduced as compared to that in the analysis with all the rules, so that the time until completion of processing shortens by the reduction.

### Sixth Embodiment

In the first to fourth embodiments, the analysis is performed with all the three types of the tag analysis, the text analysis, and the image analysis. In a sixth embodiment, analysis is performed with two types out of the three types. Any of all three combinations may be adopted.

The embodiments of the present invention have been described above with the drawings. Specific configurations are not limited to those described in the embodiments, and thus alterations and additions made without departing from the scope of the spirit of the present invention are to be included in the present invention.

Although the embodiments of the present invention have been described with the document-composition analysis system 2 as an exemplary document-composition analysis system, a document-composition analysis system according to an embodiment of the present invention may include a single device.

A method or a rule of analyzing the composition of a document is not limited to the methods described in the embodiments of the present invention.

A method of calculating the degree of confidence is not limited to the methods described in the embodiments. For example, when performing an analysis with each rule, numerical conversion may be performed as to what degree each rule has suited to the entire document (suitability), and the degree of confidence may be calculated on the basis of the suitability.

According to an embodiment of the present invention, a document-composition analysis device, a document-composition analysis method, and a document-composition analysis system according to an embodiment of the present invention enable a document composition to be analyzed without complication of a criterial rule for analysis.

Although embodiments of the present invention have been described and illustrated in detail, the disclosed embodiments are made for purposes of illustration and example only and not limitation. The scope of the present invention should be interpreted by terms of the appended claims.

What is claimed is:

1. A document-composition analysis system comprising
a hardware processor that analyzes a logical composition of a document with mutually different methods, and determines a final logical composition of the document based on analyzed results of the hardware processor.

2. The document-composition analysis system according to claim 1, wherein
the hardware processor derives a degree of reliability to each of the analyzed results, and determines the final logical composition of the document based on the degree of reliability derived by the hardware processor.

3. The document-composition analysis system according to claim 2, wherein
the hardware processor adopts, to the final logical composition of the document, an analyzed result having the degree of reliability with a highest value, from among the analyzed results of the hardware processor.

4. The document-composition analysis system according to claim 2, wherein
the hardware processor has a plurality of rules and determines the degree of reliability based on a type of a suited rule or suitability to the rules.

5. The document-composition analysis system according to claim 1, wherein
the hardware processor applies majority rule to the analyzed results of the hardware processor and determines the final logical composition of the document.

6. The document-composition analysis system according to claim 1, wherein
the hardware processor analyzes the logical composition of the document based on a tag.

7. The document-composition analysis system according to claim 1, wherein
the hardware processor analyzes the logical composition of the document with text analysis.

8. The document-composition analysis system according to claim 1, wherein
the hardware processor analyzes the logical composition of the document with image analysis.

9. A document-composition analysis method comprising:
analyzing a logical composition of a document with mutually different methods; and
determining a final logical composition of the document based on analyzed results of the analyzing with the mutually different methods.

10. The document-composition analysis method according to claim 9, wherein
the analyzing with each of the mutually different methods includes deriving a degree of reliability to the analyzed result, and
the determining includes determining the final logical composition of the document based on the degree of reliability derived in the analyzing with each of the mutually different methods.

11. The document-composition analysis method according to claim 10, wherein
the determining includes adopting, to the final logical composition of the document, an analyzed result having the degree of reliability with a highest value, from among the analyzed results of the analyzing with the mutually different methods.

12. The document-composition analysis method according to claim 10, wherein
the analyzing with each of the mutually different methods has a plurality of rules and includes determining the degree of reliability based on a type of a suited rule or suitability to the rules.

13. The document-composition analysis method according to claim 9, wherein
the determining includes applying majority rule to the analyzed results of the analyzing with the mutually different methods and determining the final logical composition of the document.

14. The document-composition analysis method according to claim 9, wherein
the analyzing with one of the mutually different methods includes analyzing the logical composition of the document based on a tag.

15. The document-composition analysis method according to claim 9, wherein
the analyzing with one of the mutually different methods includes analyzing the logical composition of the document with text analysis.

16. The document-composition analysis method according to claim 9, wherein
the analyzing with one of the mutually different methods includes analyzing the logical composition of the document with image analysis.

17. A non-transitory recording medium storing a computer readable program causing an information processing device to perform the document-composition analysis method according to claim 9.
